(19) United States
(12) Patent Application Publication
(10) Pub. No.: US 2022/0002468 A1
(43) Pub. Date: Jan. 6, 2022

(54) POLYURETHANE OR POLYURETHANE-UREA COMPOSITIONS WITH REDUCED COLD HARDENING

(71) Applicant: INGEVITY UK LTD., Chesire (GB)

(72) Inventors: Scott PHILLIPS, Lancashire (GB); Joel NEALE, Flintshire (GB); Joseph SCHOLES, Derbyshire (GB); Hakan BJORNBERG, Malmo (SE)

(21) Appl. No.: 17/294,206

(22) PCT Filed: Nov. 14, 2019
(86) PCT No.: PCT/EP2019/081288

§ 371 Date: May 14, 2021

(51) Int. Cl. C08G 18/48; C08G 18/12; C08G 18/76; C08G 18/32; C08G 18/66; C09D 175/08; C09J 175/08; C09K 3/10

(52) U.S. Cl. CPC C08G 18/4887; C08G 18/12; C08G 18/7671; C08G 18/3206; C09K 2200/065; C09D 175/08; C09J 175/08; C09K 3/1021; C08G 2110/00; C08G 18/6674

(57) ABSTRACT

A polyurethane or polyurethane-urea composition with reduced cold hardening being the reaction product of: a) at least one block copolymer of A-B-A type with an average number molecular weight of 1000 to 5000 g/mol, and being the reaction product of a poly(alkylene oxide) diol and a cyclic lactone or ether, the poly(alkylene oxide) diol being present in the range 30-70 wt % of the block copolymer and the cyclic lactone or ether is present in the range 30-70 wt, and b) at least one diisocyanate, and associated uses of the same.

### CROSS-REFERENCE TO RELATED APPLICATIONS

This application claims priority to PCT/EP19/081,288, filed on Nov. 14, 2019, which claims priority to Swedish Application No. 1830336.2, filed on Nov. 15, 2018, which was granted (Swedish Patent No. 542,934), the contents of which are herein incorporated in their entirety.

### BACKGROUND

### Field of the Invention

Presently described are polyurethane elastomer compositions based on a polyol designed to maintain the softness in low-isocyanate systems, while ensuring the durability of articles during the service lifetime.

### Background Information

Polyurethane elastomers are versatile materials that are of extreme industrial importance due to the combination of good mechanical properties with ease and flexibility of processing. For example, polyurethane materials can be processed by conventional thermoplastic techniques, cast to give thermoset materials, blown to give microcellular foams or dispersed in aqueous or organic media; all with just small adjustment to the formulation.

Polyurethane elastomers are typically composed of polyols (usually polyester adipates, polycaprolactones or polyether diols), diisocyanates (usually organic disocyanate), and short chain diols or diamines (chain extenders). The proportion of diisocyanate component in the formulation primarily dictates the hardness of the resulting polyurethane material.

One well-known limitation of polyurethane technology is the challenges in producing soft materials (less than 75 Shore A). For example, reducing the diisocyanate content (and thus elevating the polyol content) may give soft materials initially, but hardness builds over time due to the semi-crystalline nature of the polyols. Thus, products can be formulated to be soft but will harden significantly over time, especially in harsh environments. There are also processing challenges; soft polyurethanes often have problems to solidify quickly enough to allow economically viable throughput.

Several methods have been disclosed with respect to preparing soft polyurethane materials. Canadian patent 1 257 946 claims the use of particular phthalate and phosphate plasticizers to give TPUs with a hardness of 60 to 80 Shore A. Plasticizers have the disadvantage of migrating from the part leading to cold hardening, fogging of surrounding surfaces, and odour problems. It is also a quite common problem that the plasticized product becomes sticky and unpleasing to touch with age. Many plasticizers, in particular phthalate based ones, are in the process of being deregulated for environmental as well as health reasons.

In order to disrupt crystallinity and maintain softness without the use of plasticizers, prior art has focused on introducing random copolymers as the polyol component. US 2008/0139774 claims the use of branched polyester adipate diols in TPU formulations. It teaches that hardness can be maintained for up to 5 days at 23° C. (i.e. room temperature) and in the refrigerator. WO 2014/195211 has disclosed a TPU containing no plasticizers having a hardness of 30 to 55 Shore A based on a linear polyester polyol derived from an aliphatic dicarboxylic acid and an aliphatic diol. However, in accordance with standard testing regime applied in WO 2014/195211, the results of very soft TPU formulations only indicate properties with a very short life span.

Much effort has focused on producing random copolymers using polyester adipate technology. Whilst this is perceived as the best strategy to minimise cold hardening, maintenance of a soft material has not been demonstrated in the literature for longer than 5 days. The products also have the disadvantage of having a poor durability profile; residual acid from the condensation polymer rapidly degrades downstream polyurethane products in the presence of water.

Ring opening polymerisation, particularly the ring opening of caprolactone, offers a chemically different way to prepare polyols. The process proceeds rapidly in the presence of small amounts of catalyst and is pH neutral meaning that the products have negligible acid values.

There are difficulties in producing random copolymers using such technology due to the mismatch in reactivity between cyclic monomers. However, this technology is a convenient way to make A-B-A block copolymers. Previously it was thought that such copolymers would be unsuitable for producing soft materials as there are still considerable lengths of ‘homopolymer’ within the block copolymer. In fact, U.S. Pat. No. 6,140,453 teaches against the use of copolymers of polypropylene glycol in TPU formulation below 86 Shore A.

Despite high demand, particularly for wearable plastics technology and parts for automotive interiors, there are relatively few commercially available solutions for soft polyurethane materials. Progress has been made but there are yet no solutions that can give a soft material, that more importantly remains soft during the service life of the material, especially in challenging environmental conditions.

Due to the lack of polyurethane technology to fully address such issues, either costly fluoroelastomers, hard-to-process silicone elastomers or materials with poor mechanical properties such as TPO have been adopted when soft plastic materials are required.

### SUMMARY

It has surprisingly and unexpectedly been found that copolymers of poly(alkylene) oxide, such as polypropylene glycol and poly(butylene oxide), and ε-caprolactone can be employed in low isocyanate formulations, to yield soft polyurethane materials that maintain their softness for about 6 months or more. Further, the materials exhibit superior resistance to hydrolytic degradation compared to polyurethanes based on polyester adipate technology. The more hydrophobic nature of the A block leads to better phase separation compared to a polyester homopolymer meaning the rate of diisocyanate crystallisation is enhanced, thus improving demold times. In addition, the products exhibit reduced or no tack. Polyurethane materials as described herein offer a relatively inexpensive alternative to materials such as fluoroelastomers and silicone elastomers, as well as polyurethanes based on niche polyester adipates. Accordingly, the description provides polyurethane or polyurethane-urea compositions with reduced cold hardening.

### BRIEF DESCRIPTION OF THE DRAWINGS

FIG. 1. Shows a comparison of hardening over time at 23° C.

FIG. 2. Shows a comparison of Shore A hardening over time in %

FIG. 3. Shows the effect of the percentage of the molecular weight of the B component in branches of the linear polyol chain.

### DETAILED DESCRIPTION

The description provides a composition comprising the reaction product of:

a) at least one block copolymer of A-B-A type having an average number molecular weight from 1000 to 5000 g/mol, said block copolymer being the reaction product of a poly(alkylene oxide) diol and a cyclic lactone or cyclic ether, said poly(alkylene oxide) diol being present in the range 30-70 wt % of the total molecular weight of the block copolymer and said cyclic lactone or cyclic ether is present in the range 30-70 wt % of the total molecular weight of the block copolymer; and

b) at least one diisocyanate.

In certain embodiments, the composition comprises a reaction product of a), b) and c) a diol or diamine chain extender having a molecular weight from 60 to 600 g/mol, said reaction product being formed in the absence of plasticizer by reaction a), b) and c) in an NCO:OH molar ratio of from 0.9:1 to 2:1.

In certain embodiments, the composition as described herein demonstrates at least one of a hardness in the range 30-80 Shore A, <5% cold hardening after 6 months at 23° C. and/or 4° C., and retention of mechanical properties (e.g. tensile strength, ultimate elongation, modulus of elasticity, compression set) after submersion in water at 70° C. or a combination thereof.

In accordance with any of the aspects or embodiments described herein, the NCO:OH molar ratio is in the range 0.9:1-1.7:1.

In accordance with any of the aspects or embodiments described herein, the NCO:OH molar ratio is in the range 0.95:1-1.5:1

In accordance with any of the aspects or embodiments described herein, the NCO:OH molar ratio is in the range 1:1-1.2:1.

In accordance with any of the aspects or embodiments described herein, the block copolymer comprises a linear backbone with branched portions where an average of at least 20%, or at least 25% of the molecular weight of the poly(alkylene) oxide unit is present as branches on the linear chain. “Branching” as used herein is to be understood as pendant alkyl groups on the linear backbone.

Without being limited to any particular theory, it is believed that the branching on the flexible portions of composition will hinder crystallization, which is the main cause behind thermoplastic urethanes hardening with time.

In accordance with any of the aspects or embodiments described herein, the poly(alkylene) oxide diol is selected from the group consisting of poly(propylene) glycol, poly(butylene oxide) diol and mixtures thereof while the cyclic lactone is ε-caprolactone. In accordance with any of the aspects or embodiments described herein, the cyclic ether is selected from the group consisting of ethylene oxide, propylene oxide, 1,2-butylene oxide, 2,3-butylene oxide, tetrahydrofuran, methyltetrahydrofuran and a mixture thereof.

In accordance with any of the aspects or embodiments described herein, the diisocyanate is selected from the group consisting of 4,4′-diphenylmethanediisocyanate, isophorone diisocyanate, 1,6-hexamethylene diisocyanate, toluene-2,4-diisocyanate, 1,5-napthylene diisocyanate, 4,4′-dicyclohexylmethane diisocyanate and mixtures thereof.

In accordance with any of the aspects or embodiments described herein, the diol chain extender is selected from a group of ethylene glycol, 1,4-butanediol, 1,6-hexanediol, 1,4-di-(betahydroxyethyl)-hydroxyquinone, 1,4-di-(betahydroxyethyl)-bisphenol A and mixtures thereof.

In accordance with any of the aspects or embodiments described herein, the diamine chain extender is selected from a group of 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl and mixtures thereof.

In accordance with any of the aspects or embodiments described herein, the block copolymer is the reaction product of polypropylene glycol and ε-caprolactone.

In accordance with any of the aspects or embodiments described herein, the block copolymer is the reaction product of poly(butylene) oxide and ε-caprolactone.

In accordance with any of the aspects or embodiments described herein, the composition of a block copolymer in accordance with a) above has an average number molecular weight in the range selected from the group consisting of 1000-1500 g/mol, 1500-2500 g/mol, 2500-3500 g/mol and 3500-5000 g/mol, where the poly(alkylene oxide) diol is present in the range 30-70 wt % of the total molecular weight of the block copolymer and that ε-caprolactone is present in the range 30-70 wt %, said poly(alkylene oxide) diol being branched and that 20-80 wt % of the poly(alkylene oxide) diol is present as branches on the linear chain.

In accordance with any of the aspects or embodiments described herein, the composition of a block copolymer in accordance with a) above has an average number molecular weight in the range 1000 to 5000 g/mol, where the polypropylene glycol is present in the range 30-70 wt % of the total molecular weight of the block copolymer and that ε-caprolactone is present in the range 30-70 mol %.

In accordance with any of the aspects or embodiments described herein, the average number molecular weight may then be in the range selected from the group consisting of 1000 to 1500 g/mol, 1500-2500 g/mol, 2500-3500 g/mol and 3500-5000 g/mol, where the polypropylene glycol is present in the range 30-70 wt % of the total molecular weight of the block copolymer and that ε-caprolactone is present in the range 30-70 mol %.

In accordance with any of the aspects or embodiments described herein, the average number molecular weight may then be in the range selected from the group consisting of 1000 to 1500 g/mol, 1500-2500 g/mol, 2500-3500 g/mol and 3500-5000 g/mol, where the poly(butylene) oxide diol is present in the range 30-70 wt % of the total molecular weight of the block copolymer and that ε-caprolactone is present in the range 30-70 mol %.

In accordance with any of the aspects or embodiments described herein, a block copolymer in accordance with a) above has an average number molecular weight of 1800-2200 g/mol, where polypropylene glycol is present in the range 45-55 wt % of the total molecular weight of the block copolymer, and ε-caprolactone is present in the range 45-55 wt %.

In accordance with any of the aspects or embodiments described herein, a block copolymer in accordance with a) above has an average number molecular weight of 2800-3200 g/mol, where polypropylene glycol is present in the range 65-70 wt % of the total molecular weight of the block copolymer, and ε-caprolactone is present in the range 30-35 wt %.

In accordance with any of the aspects or embodiments described herein, a block copolymer in accordance with a) above has an average number molecular weight of 1800-2200 g/mol, where the poly(butylene) oxide diol is present in the range 45-55 wt % of the total molecular weight of the block copolymer, and ε-caprolactone is present in the range 45-55 wt %.

In accordance with any of the aspects or embodiments described herein, a block copolymer in accordance with a) above has an average number molecular weight of 2800-3200 g/mol, where the poly(butylene) oxide diol is present in the range 65-70 wt % of the total molecular weight of the block copolymer, and ε-caprolactone is present in the range 30-35 wt %.

The description also provides for the use of the composition of the present invention, in particular in a method of use of a polymer composition with reduced cold hardening properties for processing as a thermoplastic polyurethane, a hot cast elastomer, a cold cast elastomer, a microcellular polyurethane foam, a polyurethane dispersion in aqueous or organic media, a polyurethane adhesive, a 1- or 2-component polyurethane coating, an additive manufacturing or a polyurethane sealant. The polymer composition comprises the components a), b), and optionally c) wherein:

a) is a block copolymer of A-B-A type having an average number molecular weight from 1000 to 5000 g/mol. The block copolymer is the reaction product of a poly(alkylene oxide) diol and a cyclic lactone or cyclic ether where the alkylene oxide polymer (A) constitutes 30-70 wt % of the total molecular weight of the A-B-A type block copolymer establishing a linear backbone with branched portions where an average of at least 20 wt % of the molecular weight of the alkylene oxide polymer (A) is present as branches on the linear chain and said cyclic lactone or cyclic ether is present in the range 30-70 wt % of the total molecular weight of the block copolymer, and,

b) is at least one diisocyanate, and optionally

c) is a diol or diamine chain extender having a molecular weight from 60 to 600.

The reaction product is formed in the absence of plasticizer by reaction a), b) and optionally c) in an NCO:OH molar ratio of from 0.9:1 to 2:1, whereas a polymer composition with the architecture:
i) [-b)-a)]ₙ where ₙ is >5
or optionally;
ii) [-b)-c)-b)-a)-b)]ₙ-a) where ₙ is >4
is obtained, said polymer composition maintaining its soft properties as measured as Shore A within ±5% 6 months after being produced.

In accordance with any of the aspects or embodiments described herein, the composition is processed as a thermoplastic polyurethane, hot cast elastomer or cold cast elastomer.

In accordance with any of the aspects or embodiments described herein, the composition is processed as a thermoplastic polyurethane or hot cast elastomer.

In accordance with any of the aspects or embodiments described herein, the composition is used for producing elastomeric thermoplastic filaments for use in additive manufacturing. The compositions as described herein are advantageous, as crystallization in prior art materials will render it cumbersome to find and set print parameters used for the printing process in the additive manufacturing. A material that changes properties over time, like herein disclosed in comparative examples makes it impossible to utilize standard printing parameters for specific materials. However, with the compositions as described herein, standardized printing parameters will be possible and setup times can be minimized at the same time as printed results will become more reliable. Compositions in the range 30-120 Shore A, preferably 60-120 Shore A are advantageous.

### EXAMPLES

### Examples 1-9

To prepare polyurethane elastomer materials according to Table 1, the requisite polyol was first added dropwise to molten 4,4′-diphenylmethanediisocyanate and reacted at 80° C. for 2 h. This yielded a polyurethane prepolymer according of approximately 4% NCO. To this, 1,4-butanediol was added, according to 97% stoichiometry or 103 isocyanate index, and the mixture homogenised using a vortex mixer for 2 min. The reaction mixture was then poured onto a coated metal plate that had been conditioned at 120° C. for 1 h. The cast sheets were then placed in an oven at 120° C. for 16 h before being demoulded and cooled to 23° C. Examples 1-5 were easily removed from the mold and no tackiness was observed.

### Examples 11 and 12

2.1 kg of 4,4′-diphenylmethanediisocyanate, 0.4 kg of 1,4-butanediol (containing 150 ppm dibutyltin dilaurate) and 7.5 kg of the block copolymer were continuously mixed at a rate of 10 kg/h in a twin screw extruder with a temperature profile between 190-260° C. and a die temperature of 170° C. The extrudate was cooled in a water-bath, cooled by air and granulated under standard temperature and humidity conditions. The granules were pressed above the melting point to form 6 mm TPU sheets.

TABLE 1

| | Total | | | | | % of MW of B | |
|---|---|---|---|---|---|---|---|
| | molecular | | Molecular | | Molecular | component | |
| | weight of | | Weight of A | | Weight of B | present as | Wt % |
| Example | copolymer | A component | Component | B component | Component | branches | MDI |
| 1 | 2000 | ε-caprolactone | 1000 | Polypropylene | 1000 | 27% | 20.8 |
| | | | | glycol | | | |
| 2 | 2000 | ε-caprolactone | 1000 | Polypropylene | 1000 | 27% | 18.3 |
| | | | | glycol | | | |
| 3 | 3000 | ε-caprolactone | 1000 | Polypropylene | 2000 | 27% | 21.8 |
| | | | | glycol | | | |
| 4 | 3000 | ε-caprolactone | 1000 | Polybutylene | 2000 | 40-43% | 21.8 |
| | | | | oxide diol | | | |
| 5 | 3000 | ε-caprolactone | 1000 | Polybutylene | 2000 | 40-43% | 16.9 |
| | | | | oxide diol | | | |
| 6* | 2000 | | | Poly- | 2000 | 0% | 20.8 |
| | | | | caprolactone | | | |
| | | | | diol | | | |
| | | | | Homopolymer | | | |
| 7* | 2000 | | | Polyester | 2000 | 0% | 20.8 |
| | | | | adipate diol | | | |
| 8* | 2000 | ε-caprolactone | 1575 | Polypropylene | 425 | 27% | 20.8 |
| | | | | glycol | | | |
| 9* | 2000 | ε-caprolactone | 1000 | Poly(tetra- | 1000 | 0% | 20.8 |
| | | | | methylene) | | | |
| | | | | glycol | | | |
| 10* | 2000 | ε-caprolactone | 1000 | Poly(methyl- | 1000 | 15% | 20.8 |
| | | | | tetramethylene) | | | |
| | | | | glycol | | | |
| 11 | 2000 | ε-caprolactone | 1000 | Polypropylene | 1000 | 27% | 20.8 |
| | | | | glycol | | | |
| 12* | 2000 | | | Poly- | 2000 | 0% | 20.8 |
| | | | | caprolactone | | | |
| | | | | diol | | | |
| | | | | Homopolymer | | | |

*Comparative example not according to the invention

Branches is to be understood as pendant alkyl group on the linear backbone.

The initial hardness of the polyurethane elastomer materials was determined in accordance with ASTM D 2240-15 after 1 day. The sheets were placed either in a conditioning oven at 23° C./50% R.H. or in a refrigerator at 4° C. Hardness was measured over a period of 6 months.

A soft material was produced directly in each example of the invention and there was shown to be less than 5% increase in hardness over a period of 6 months (Examples 1-5 and 11). On the contrary, when a polycaprolactone homopolymer was used, hardness developed quickly over time (Examples 6 and 12). When a polyester adipate (random compolymer) was used, hardness also developed quickly (Example 7). When the proportion of the B component was less than 30 wt % of the molecular weight of the compolymer then hardness developed quickly (Example 8). When the B component was a polyol having less than 25 wt % of its molecular weight in the side chain then hardness developed quickly (Examples 9 and 10). Examples of the invention were prepared via a hot cast production process (Examples 1-5) and a thermoplastic polyurethane (TPU) production process (Example 11).

TABLE 2

| | Initial Hardness | 1 month | 6 months | 1 month | 6 months | % change | % change |
|---|---|---|---|---|---|---|---|
| Example | (Shore A) | at 23° C. | at 23° C. | at 4° C. | at 4° C. | (23° C.) | (4° C.) |
| 1 | 60 | 62 | 62 | 62 | 62 | 3.3 | 3.3 |
| 2 | 52 | 53 | 54 | 53 | 54 | 3.8 | 3.8 |
| 3 | 58 | 58 | 58 | 59 | 58 | 0.0 | 0.0 |
| 4 | 61 | 62 | 62 | 63 | 63 | 1.6 | 3.3 |
| 5 | 41 | 42 | 41 | — | — | 0.0 | — |
| 6* | 60 | 71 | 71 | 72 | 71 | 18.3 | 18.3 |
| 7* | 61 | 73 | 74 | 76 | 77 | 21.3 | 26.2 |
| 8* | 60 | 64 | 66 | 65 | 67 | 10.0 | 11.7 |
| 9* | 60 | 70 | 73 | 74 | 74 | 21.6 | 23.3 |
| 10* | 61 | 73 | 72 | 74 | 74 | 18.0 | 21.3 |
| 11 | 61 | — | 63 | — | — | 3.3 | — |
| 12* | 62 | — | 74 | — | — | 19.3 | — |

The compositions according to invention shows a radical improvement in maintaining its soft properties over time where a typical hardening is below 4% while compositions in accordance with prior art at best hardens more than 18% and at worst more than 26% over a 6 month period.

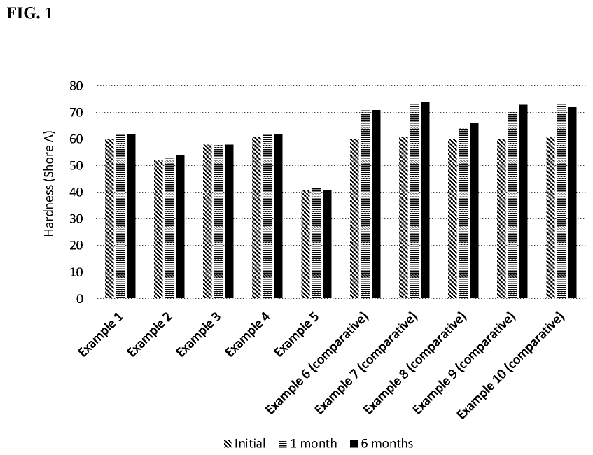

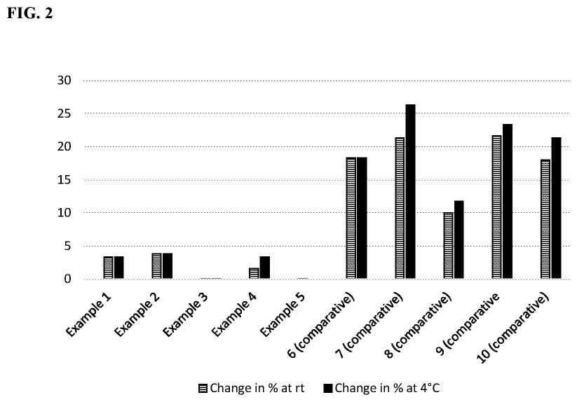

FIG. 1 and FIG. 2 illustrates further the difference in hardening over time between the compositions in accordance with the invention and compositions in accordance with prior art.

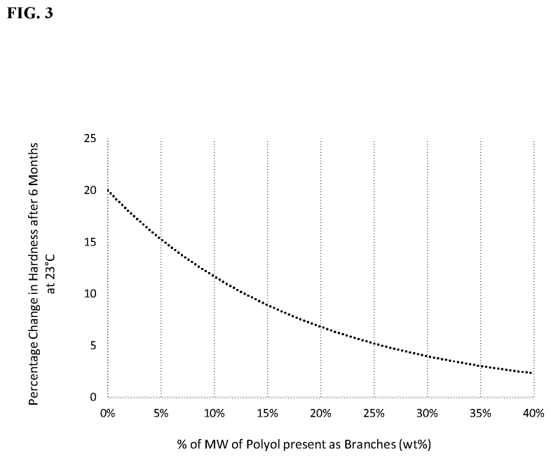

FIG. 3 illustrates the effect of the percentage of the molecular weight of the B component in branches of the linear polyol chain. When more than 25 wt % is present in the branch chain then cold hardening is avoided (<5% over six months at 23° C.).

According to the invention, soft polyurethane materials with exceptional hydrolytic stability were produced. Using an in-house method, polyurethane elastomer samples were submerged in water at 70° C. and the tensile properties were measured over a period of 21 days. Polyols prepared using caprolactone technology in accordance with the present invention offers distinct advantages over prior art polyester adipates. The results are shown in Table 3.

TABLE 3

| | Time to 60% Retained tensile strength | |
|---|---|---|
| 1 | 14 | days |
| 2 | >21 | days |
| 6* | >21 | days |
| 7* | 1 | day |

*comparative

The extent of hard segment crystallisation is indicative of the rate at which polyurethane materials will crystallise and give products that can be demolded in a timely manner. Such information is valuable to ensure that new products can be produced with commercially viable cycle times. Table 4 shows that the melting enthalpy of the hard segment for examples of this invention is over 100 times greater than where the polycaprolactone hompolymer is used as the soft segment, and in the same order of magnitude as commercially available 80 Shore A materials.

Thermal analysis was carried out using a Mettler Toledo DSC823e at a heating rate of 3° C. per minute.

TABLE 4

| | Onset | Peak | Enthalpy |
|---|---|---|---|
| | ° C. | ° C. | J/g |
| 1 | | 175.7 | 1.10 |
| 3 | 196.3 | 203.4 | 1.79 |
| 4 | 198.4 | 204.1 | 1.93 |
| 6* | 161.6 | 173.9 | 0.01 |

*comparative. The melting enthalpy of an 80 Shore A polyurethane elastomer based on polycaprolactone homopolymer is 4 J/g.

Articles in accordance with the present invention show remarkable mechanical properties. Such mechanical properties can be improved further within the scope of the invention by careful choice of chain extender.

Table 5 shows mechanical properties of different compositions in accordance with the present invention and in comparison with a composition prepared using a commercially available polycaprolactone homopolymer.

TABLE 5

| | Modulus | | | | | | | Glass |
|---|---|---|---|---|---|---|---|---|
| | of | 100% | 200% | 300% | Tensile | Ultimate | Ball | Transition |
| | Elasticity | Modulus | Modulus | Modulus | Strength | Elongation | Rebound | Temperature |
| 1 | 5.2 | 1.9 | 2.5 | 3.1 | 24.9 | 1858 | 55 | −43.2 |
| 2 | 3.8 | 1.0 | 1.3 | 1.5 | 15.3 | 2118 | 49 | −40.1 |
| 3 | 7.6 | 1.7 | 2.2 | 2.6 | 9.9 | 1949 | 55 | −50.9 |
| 4 | 3.9 | 1.9 | 2.7 | 3.3 | 10.3 | 1584 | 48 | −53.4 |
| 6* | 9.3 | 2.5 | 3.3 | 4.0 | 22.5 | 1231 | 54 | −45.1 |

The results presented in Table 5 shows that not only is it possible to extend the useful service through retaining the initial soft properties of a composition over time as presented in Tables 2A-2D in accordance with the invention; it is also possible to maintain the mechanical properties—such as tensile strength, ultimate elongation and elastic modulus—and viscoelastic properties (such as ball rebound resilience) at the same levels as if a commercially available polycaprolactone homopolymer was used. Such mechanical and viscoelastic properties offer distinct advantages over competitive technologies such as silicone elastomers, fluororelastomers and TPOs.

Not only is the softness of the materials maintained throughout the service lifetime, degradation of the materials is retarded due to the superior durability of polycaprolactone-based chemistry. As with articles made with polycaprolactone homopolymer, these materials are resistant to the effects of water, sunlight and industrial chemicals; maintain performance at both low temperature and high temperature extremes; and have excellent heat dissipation properties. The increased hydrophobicity of the materials make them ideal for use in applications where stain resistance is important. The reduced crystallinity has the benefit of avoiding the formation of haze in finished articles during the service lifetime.

The copolymers can be prepared easily using standard commercial technologies; all raw materials are produced in multi-ton quantities. The copolymers have low melting points (less than polycaprolactone copolymers) and can be incorporated into any current polyurethane production process seamlessly. The invention has the added benefit over competitive technologies in that the polyurethane final materials can be processed easily using standard thermoplastic production equipment.

What is claimed is:

1. A polyurethane or polyurethane-urea composition with reduced cold hardening, comprising the reaction product of:
a) at least one block copolymer of A-B-A type having an average number molecular weight from 1000 to 5000 g/mol, said block copolymer being the reaction product of a poly(alkylene oxide) diol and a cyclic lactone or cyclic ether, said poly(alkylene oxide) diol being present in the range 30-70 wt % of the total molecular weight of the block copolymer, wherein said block copolymer comprises a linear backbone with branched portions where an average of at least 20 wt % of the molecular weight of the poly(alkylene) oxide unit is present as branches on the linear chain, and said cyclic lactone or cyclic ether is present in the range 30-70% of the total molecular weight of the block copolymer; and
b) at least one diisocyanate.

2. The composition of claim 1, wherein the composition is a reaction product of a), b) further with c) a diol or diamine chain extender having a molecular weight from 60 to 600 g/mol, said reaction product being formed in the absence of plasticizer by reaction a), b) and c) in an NCO:OH molar ratio of from 0.9:1 to 2:1.

3. The composition of claim 1, wherein the composition has a hardness in the range 30 Shore A to 80 Shore A.

4. The composition of claim 1, wherein the NCO:OH molar ratio is in the range 0.9:1-7:1.

5. The composition of claim 1, wherein the NCO:OH molar ratio is in the range 0.95:1-5:1.

6. The composition of claim 1, wherein the NCO:OH molar ratio is in the range 1:1-2:1.

7. The composition of claim 1, wherein at least 25% of the molecular weight of the poly(alkylene) oxide unit is present as branches on the linear chain.

8. The composition of claim 1, wherein the poly(alkylene) oxide diol is selected from the group consisting of poly(propylene) glycol, poly(butylene oxide) diol and mixtures thereof.

9. The composition of claim 1, wherein the cyclic lactone is ε-caprolactone.

10. The composition of claim 1, wherein the cyclic ether is ethylene oxide, propylene oxide, 1,2-butylene oxide, 2,3-butylene oxide, tetrahydrofuran, or methyltetrahydrofuran.

11. The composition of claim 1, wherein the diisocyanate is selected from the group consisting of 4,4′-diphenylmethanediisocyanate, isophorone diisocyanate, 1,6-hexamethylene diisocyanate, toluene-2,4-diisocyanate, 1,5-napthylene diisocyanate, 4,4′-dicyclohexylmethane diisocyanate and mixtures thereof.

12. The composition of claim 2, wherein the diol chain extender is selected from a group of ethylene glycol, 1,4-butanediol, 1,6-hexanediol, 1,4-di-(betahydroxyethyl)-hydroxyquinone, 1,4-di-(betahydroxyethyl)-bisphenol A and mixtures thereof.

13. The composition of claim 2, wherein the diamine chain extender is selected from a group of 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl and mixtures thereof.

14. The composition of claim 8, wherein the polypropylene glycol or poly(butylene oxide) diol is present in the range 50-70 wt % of the total molecular weight of the block copolymer.

15. The composition of claim 1, wherein the composition maintains its soft properties as measured as Shore A within ±5% 6 months after being produced.

16. Method of making a polyurethane or polyurethane-urea composition with reduced cold hardening comprising the steps of reacting:
a) at least one block copolymer of A-B-A type having an average number molecular weight from 1000 to 5000 g/mol, said block copolymer being the reaction product of a poly(alkylene oxide) diol and a cyclic lactone or cyclic ether, said poly(alkylene oxide) diol being present in the range 30-70 wt % of the total molecular weight of the block copolymer, wherein said block copolymer comprises a linear backbone with branched portions where an average of at least 20 wt % of the molecular weight of the poly(alkylene) oxide unit is present as branches on the linear chain and said cyclic lactone or cyclic ether is present in the range 30-70% of the total molecular weight of the block copolymer; and
b) at least one diisocyanate.

17. The method of claim 16, wherein the method further comprises the step of reacting a), and b) further with c) a diol or diamine chain extender having a molecular weight from 60 to 600 g/mol, said reaction product being formed in the absence of plasticizer by reaction a), b) and c) in an NCO:OH molar ratio of from 0.9:1 to 2:1.

18. The method of claim 16, wherein the polymer composition has the architecture:
i) [-b)-a)]ₙ where ₙ is >5.

19. The method of claim 17, wherein the polymer composition has the architecture:
ii) [-b)-c)-b)-a)-b)]ₙ-a) where ₙ is >4.

20. A method of using the composition of claim 1, wherein the method comprises the steps of:
a. providing the composition of claim 1; and
b. utilizing the composition in at least one of processing as a thermoplastic polyurethane, hot cast elastomer, cold cast elastomer, microcellular polyurethane foam, polyurethane dispersion in aqueous or organic media, polyurethane adhesive, 1- or 2-component polyurethane coating, additive manufacturing or polyurethane sealant.
